(19) United States
(12) Patent Application Publication
(10) Pub. No.: US 2006/0117048 A1
(43) Pub. Date: Jun. 1, 2006

(54) Method and system of synchronizing filter metadata after a restore

(75) Inventors: Ravinder S. Thind, Kirkland, WA (US); Neal R. Christiansen, Bellevue, WA (US); Sarosh Cyrus Havewala, Redmond, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 10/999,529

(22) Filed: Nov. 30, 2004

(51) Int. Cl. G06F 7/00

(52) U.S. Cl. 707/101

(57) ABSTRACT

A method and system for updating a filter's data after the filter's metadata file is restored. The filter maintains an open handle to the metadata until the filter receives a request to have the metadata restored. The filter then closes the open handle and allows the metadata to be restored. After the metadata is restored, data associated with the filter is rebuilt based on the restored metadata.

### FIELD OF THE INVENTION

The invention relates generally to computers, and more particularly to file systems.

### BACKGROUND

With contemporary operating systems, such as Microsoft Corporation's Windows® XP operating system with an underlying file system such as the Windows® NTFS (Windows® NT File System), FAT, CDFS, SMB redirector filesystem, or WebDav file systems, one or more file system filter drivers may be inserted between the I/O manager that receives user I/O requests and the file system driver. In general, filter drivers (sometimes referred to herein simply as “filters”) are processes that enhance the underlying file system by performing various file-related computing tasks that users desire, including tasks such as passing file system I/O (requests and data) through anti-virus software, file system quota providers, file replicators, and encryption/compression products.

For example, antivirus products provide a filter that watches I/O to and from certain file types (.exe, .doc, and the like) looking for virus signatures, while file replication products perform file system-level mirroring. Other types of file system filter drivers are directed to system restoration (which backs up system files when changes are about to be made so that the user can return to the original state), disk quota enforcement, backup of open files, undeletion of deleted files, encryption of files, and so forth. Thus, by installing file system filter drivers, computer users can select the file system features they want and need, in a manner that enables upgrades, replacement, insertion, and removal of the components without changing the actual operating system or file system driver code.

A file system filter may maintain metadata and other data for files and directories of a volume. The metadata may be maintained in a file that is also stored on the volume while the other data may be maintained in main memory. Occasionally, objects of a volume may be restored from a backup dataset. The metadata file and the other data may contain out-of-date data when the metadata file itself is restored.

What is needed is a method and system of updating a filter's data (both metadata and other data) after the filter's metadata file is restored.

### SUMMARY

Briefly, the present invention provides a method and system for updating a filter's data after the filter's metadata file is restored. The filter maintains an open handle to the metadata until the filter receives a request to have the metadata restored. The filter then closes the open handle and allows the metadata to be restored. After the metadata is restored, data associated with the filter is rebuilt based on the restored metadata.

In one aspect, the filter detects when its metadata is restored by monitoring I/Os to the file system on which the metadata is stored. When an I/O indicates that an application is requesting to open the metadata for writing with backup intent, the filter determines that the application is restoring the metadata. If the filter maintains continuous exclusive access to the metadata, then the filter gives up the exclusive access (e.g., by closing the metadata), so that the application may restore the metadata. The filter detects when the handle used to open the metadata for restore is closed. After the handle is closed, the filter reopens the metadata and rebuilds data structures based thereon.

Other aspects will become apparent from the following detailed description when taken in conjunction with the drawings, in which:

### BRIEF DESCRIPTION OF THE DRAWINGS

FIG. 1 is a block diagram representing a computer system into which the present invention may be incorporated;

FIG. 2 is a block diagram representing an exemplary arrangement of components of a system in which the present invention may operate in accordance with various aspects of the invention;

FIG. 3 is a block diagram representing another exemplary arrangement of components of a system in which the present invention may operate in accordance with various aspects of the invention;

FIG. 4 is a block diagram representing another exemplary arrangement of components of a system in which the present invention may operate in accordance with various aspects of the invention;

FIG. 5 is a block diagram representing an exemplary arrangement of components of a system in which the present invention may be practiced in accordance with various aspects of the invention;

FIG. 6 is a block diagram that generally represents exemplary metadata in accordance with various aspects of the invention;

FIG. 7 is a block diagram generally representing a portion of a data structure created by a filter in main memory in accordance with various aspects of the invention;

FIG. 8 is a flow diagram that generally represents actions that may occur with restoring a metadata file in accordance with various aspects of the invention;

FIG. 9 is a flow diagram that generally represents actions which correspond to block 835 of FIG. 8 that may occur in rebuilding data structures in accordance with various aspects of the invention;

FIG. 10 is a flow diagram that generally represents actions which correspond to block 915 of FIG. 9 that may occur in rebuilding data structures in accordance with various aspects of the invention;

FIG. 11 is a flow diagram that generally represents actions which correspond to block 920 of FIG. 9 that may occur in rebuilding data structures in accordance with various aspects of the invention; and

FIG. 12 is a flow diagram that generally represents actions that may occur when an object of interest is restored in accordance with various aspects of the invention.

### DETAILED DESCRIPTION

Exemplary Operating Environment

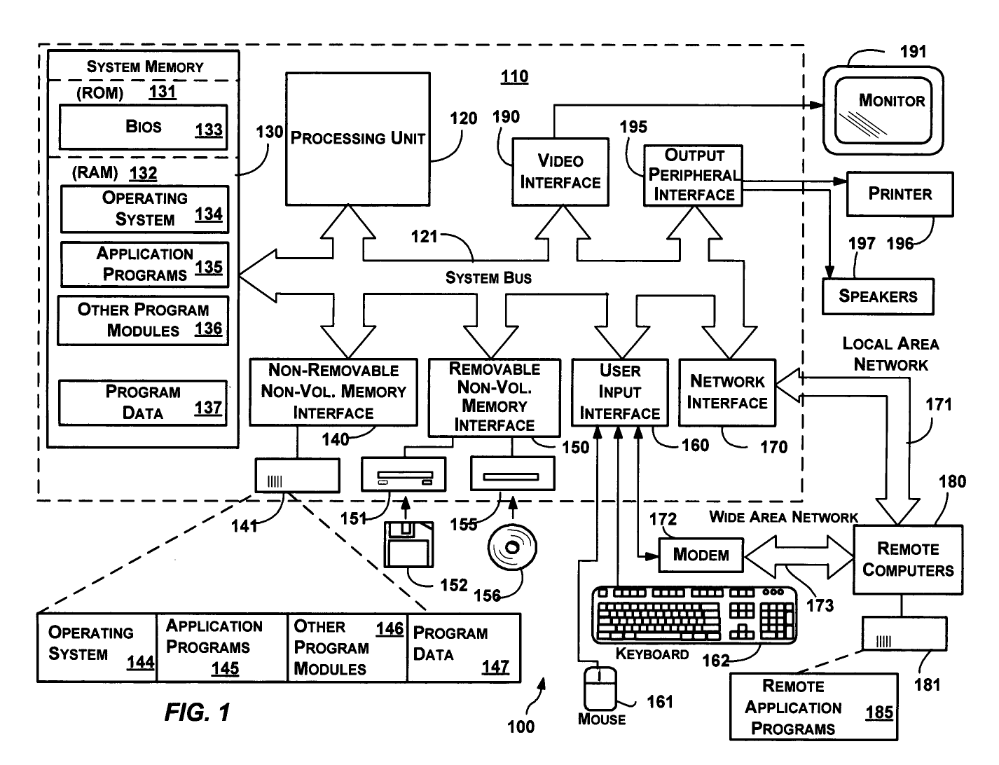

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary Filters and Arrangements Thereof

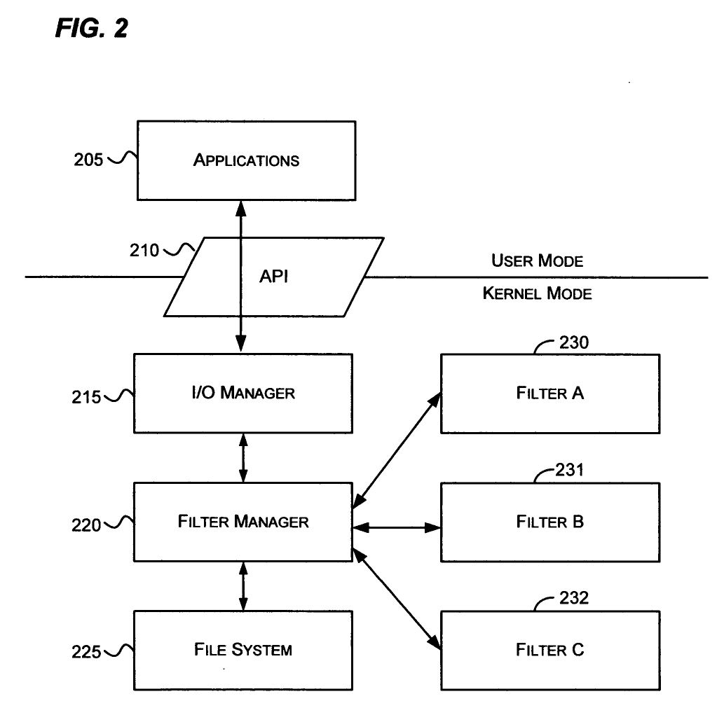

FIG. 2 is a block diagram representing an exemplary arrangement of components of a system in which the present invention may operate in accordance with various aspects of the invention. The components include one or more applications 205, an applications programming interface (API) 210, an input/output (I/O) manager 215, a filter manger 220, a file system 225, and one or more filters 230-232.

The applications 205 may make file system requests (e.g., via function/method calls) through the API 210 to the I/O manager 215. The I/O manager 215 may determine what I/O request or requests should be issued to fulfill each request and send each I/O request to the filter manager 220. The I/O manager 210 may also return data to the applications 205 as operations associated with the file system requests proceed, complete, or abort.

In one implementation, filters comprise objects or the like that when instantiated register (e.g., during their initialization procedure) with a registration mechanism in the filter manager 220. For efficiency, each filter typically will only register for file system requests in which it may be interested in processing. To this end, as part of registration, each filter notifies the filter manager 220 of the types of I/O requests in which it is interested (e.g., create, read, write, close, rename, and so forth). For example, an encryption filter may register for read and write I/Os, but not for others wherein data does not need to be encrypted or decrypted. Similarly, a quota filter may be interested only in object creates and object writes.

In addition to specifying the types of I/O requests in which it is interested, a filter may further specify whether the filter should be notified for pre-callbacks and post callbacks for each of the types of I/O. A pre-callback is called as data associated with an I/O request propagates from the I/O manager 215 towards the file system 225, while a post-callback is called during the completion of the I/O request as data associated with the I/O request propagates from the file system 225 towards the I/O manager 215.

From each I/O request, the filter manager 220 may create a data structure in a uniform format suitable for use by the filters 230-232. Hereinafter, this data structure is sometimes referred to as callback data. The filter manager 220 may then call and pass the callback data to each filter that has registered to receive callbacks for the type of I/O received by the filter manager 220. Any filters registered to receive callbacks for the type of I/Os received by the filter manager are sometimes referred to as registered filters.

Typically, the filter manager 220 passes callback data associated with a particular type of I/O request to each registered filter sequentially in an order in which the registered filters are ordered. For example, if the filters 230 and 232 are registered to receive callbacks for all read I/O requests and are ordered such that the filter 230 is before the filter 232 in processing such requests, then after receiving a read I/O, the filter manager 220 may first call and pass the callback data to the filter 230 and after the filter 230 has processed the callback data, the filter manager 220 may then call and pass the callback data (as modified, if at all) to the filter 232.

A filter may be attached to one or more volumes. That is, a filter may be registered to be called and receive callback data for I/Os related to only one or more than one volumes.

A filter may generate its own I/O request which may then be passed to other filters. For example, an anti-virus filter may wish to read a file before it is opened. A filter may stop an I/O request from propagating further and may instruct the filter manager to report a status code (e.g., success or failure) for the I/O request. A filter may store data in memory and persist (e.g., store) this data on disk. In general, a filter may be created to perform any set of actions that may be performed by a kernel-mode or user-mode process and may be reactive (e.g., wait until it receives I/O requests before acting) and/or proactive (e.g., initiate its own I/O requests or perform other actions asynchronously with I/O requests handled by the I/O manager 215).

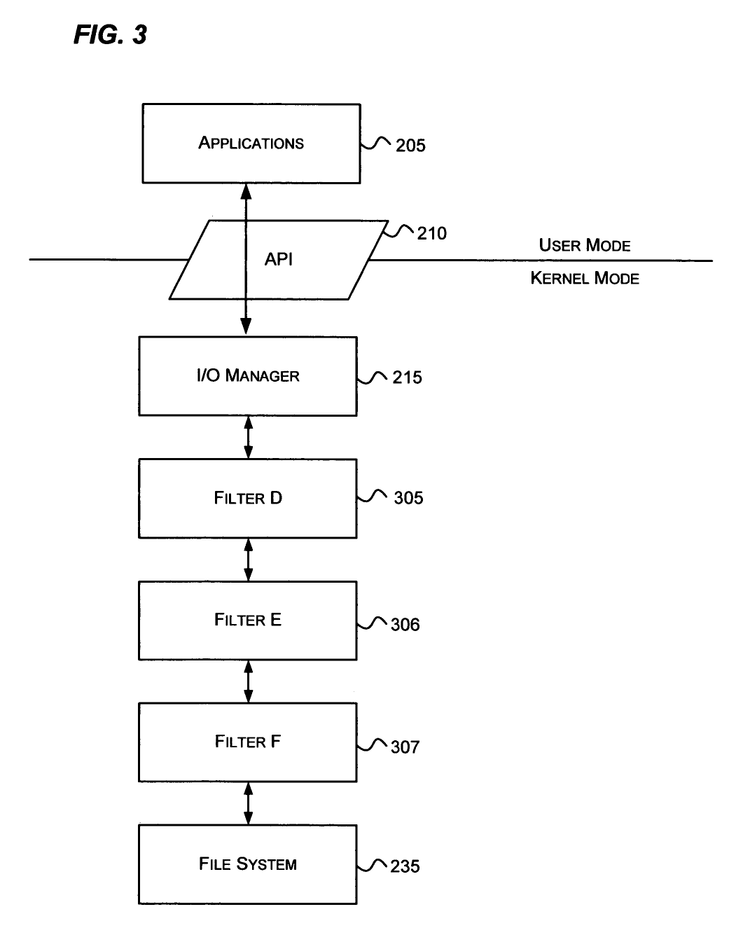

In one embodiment, filters may be arranged in a stacked manner as illustrated in FIG. 3, which is a block diagram representing another exemplary arrangement of components of a system in which the present invention may operate in accordance with various aspects of the invention. In this embodiment, each of the filters 305-307 may process I/O requests and pass the requests (modified or unmodified) to another filter or other component in the stack. For example, in response to a read request received from one of the applications 205, the I/O manager 215 may issue an I/O request and send this request to the filter 305. The filter 305 may examine the I/O request and determine that the filter 305 is not interested in the I/O request and then pass the I/O request unchanged to the filter 306. The filter 306 may determine that the filter 306 will perform some action based on the I/O request and may then pass the I/O request (changed or unchanged) to the filter 307. The filter 307 may determine that the filter 307 is not interested in the I/O request and pass the I/O request to the file system 235.

After the file system 235 services the I/O request, it passes the results to the filter 307. Typically, the results pass in an order reverse from that in which the I/O request proceeded (e.g., first to filter 307, then to filter 306, and then to filter 305). Each of the filters 305-307 may examine the results, determine whether the filter is interested in the results, and may perform actions based thereon before passing the results (changed or unchanged) on to another filter or component.

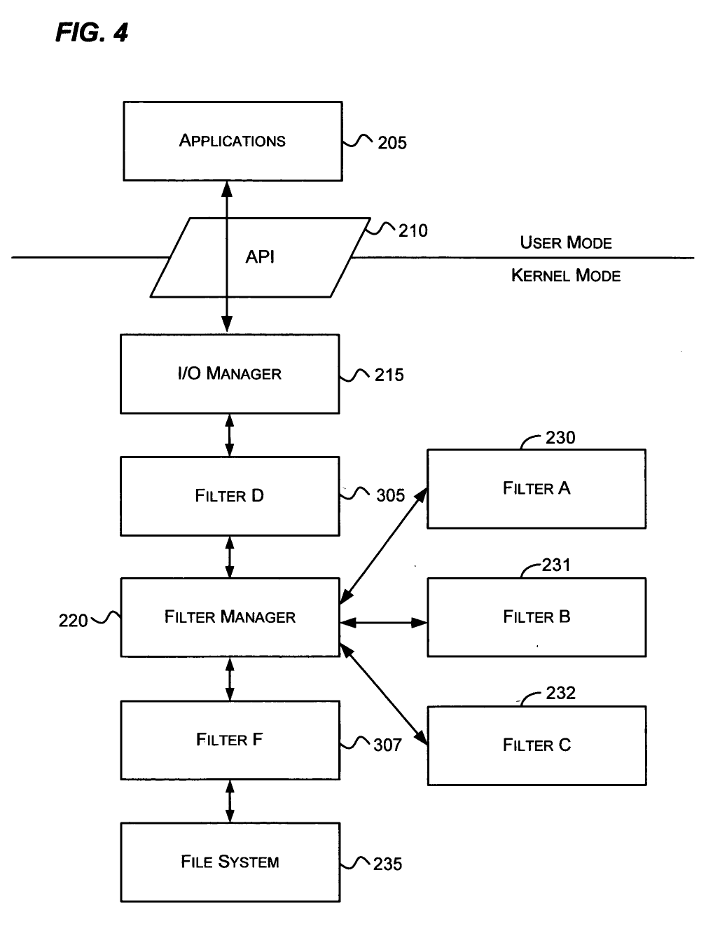

In another embodiment of the invention, filters may be arranged in a stacked/managed manner as illustrated in FIG. 4, which is a block diagram representing another exemplary arrangement of components of a system in which the present invention may operate in accordance with various aspects of the invention. In this configuration, some filters are associated with a filter manager while other filters are not. The filter manager 220 is placed in a stack with other filters (e.g., filters 305 and 307).

It will be readily recognized that filters may be implemented in many other configurations without departing from the spirit or scope of the invention. In some embodiments, a filter comprises any object that examines I/O between an application and a file system and that is capable of changing, completing, or aborting the I/O or performing other actions based thereon. Such filters may execute in user mode or in kernel mode and may be part of other components.

Returning to FIG. 2, the file system 235 may include one or more volumes that may be located locally or remotely to the machine or machines upon which the applications 205 execute.

Rebuilding Filter Data after a Restore

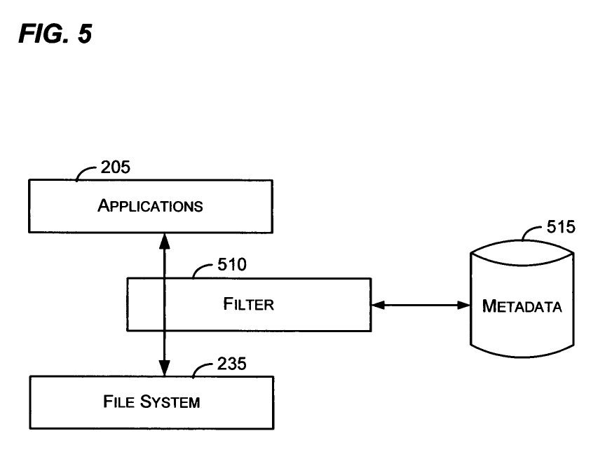

FIG. 5 is a block diagram representing an exemplary arrangement of components of a system in which the present invention may be practiced in accordance with various aspects of the invention. The system includes one or more applications 205, a filter 510, metadata 515, a file system 235 and may include other components (not shown).

When the filter 510 is attached to a volume of the file system (e.g., monitoring I/O to and from the volume), the filter 510 may make changes to the metadata 515 to keep the namespace of objects (e.g., files, directories, and the like) identified by the metadata in sync with a corresponding namespace of the volume for those objects.

In one embodiment, the metadata 515 comprises a file that is persisted in non-volatile storage. The non-volatile storage may comprise a volume the filter 510 is monitoring. When the filter 510 begins executing, it may read the metadata 515 to create data structures in main memory to assist the filter 510 in performing its functions.

The filter 510 may keep a handle open to the metadata 515 while the filter 510 executes. In one embodiment, the filter may open this handle exclusively to prevent applications from changing the file without the filter's knowledge. Keeping an open handle to the metadata 515 may allow the filter 510 to quickly update the metadata 515 when the filter 510 receives new or modified policies and when the namespace for any object of interest changes on the file system 235. A system administrator or the like may desire to restore a backup dataset or a portion thereof to the file system 235. As part of the restore, the metadata 515 itself may be restored from the backup dataset.

In some implementations, a file may not be restored unless all handles to the file are closed. As the filter 510 may maintain an open handle to the metadata 515, the filter 510 may need to close the handle so that the metadata 515 may be restored. As the filter 510 may monitor file system I/O, the filter 510 may be able to determine that an application is requesting to restore the metadata 515. In some operating systems, an application may request to restore an object by requesting to open the file for writing and indicating backup intent. In other operating system, other mechanisms may be employed to restore a metadata file.

When the filter 510 determines that an application (e.g., a backup application) is requesting to restore the metadata 515, the filter 510 may close its handle to the metadata. The filter 510 may then continue to perform any actions associated with the filter 510 (e.g., enforcing quotas, screening data, and the like) by using the data structures in main memory that the filter 510 previously created. During the restore of the metadata 515, however, the filter 510 may not update the metadata 515.

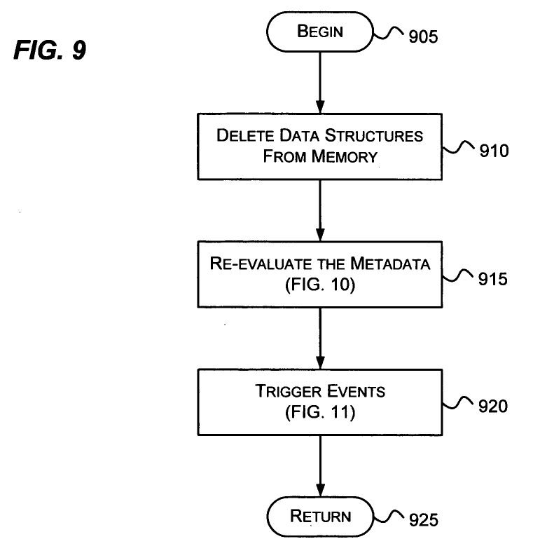

The filter 510 may also monitor I/Os to determine when the metadata 515 is restored. When the handle that was used to open the metadata 515 to restore it is closed, the filter 510 may determine that the metadata 515 is restored. At this point, the filter 510 may purge the data structures in main memory (e.g., random access memory) related to the old metadata, read the restored metadata, and build new data structures in main memory based on the restored metadata as described in more detail in conjunction with FIGS. 9-11.

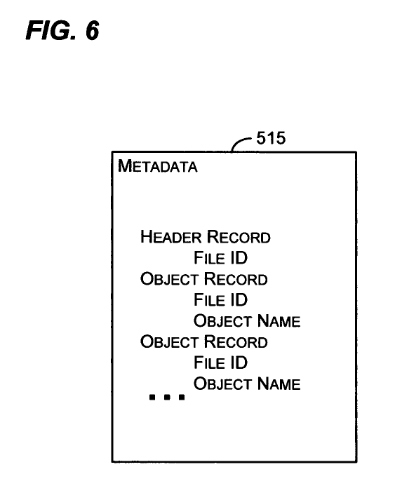

FIG. 6 is a block diagram that generally represents exemplary metadata in accordance with various aspects of the invention. For each object of interest to the filter, the namespace stored in the metadata 515 may include an identifier that identifies the object to a file system and a name that includes a path to the object.

In some embodiments, the metadata includes a header record. The header record includes a file ID that stores the file ID of the metadata file. This file ID is useful in determining whether a format and restore has taken place on the volume associated with the metadata while the filter was unattached to the volume. In some operating systems, each object stored on a file system is assigned a unique file ID. This file ID serves to identify the object and may be used in file operations to, for example, open, change, or delete the object.

When the metadata 515 or objects of a volume are restored (e.g., from a backup dataset), file IDs included in the metadata 515 may not match file IDs for these objects on the volume. Furthermore, some objects that are referenced in the metadata 515 may no longer exist on the volume. In addition, some objects that are referenced in the metadata 515 may not currently exist but may be restored as the restore proceeds. Thus, upon re-opening the metadata 515, the filter may validate and update the records included in the metadata 515 and may flag certain objects in the data structure created by the filter to indicate that these objects are dead (e.g., have not been restored yet and may have been deleted). As the filter may not know when a restore has completed, the filter may not delete records which reference objects that no longer exist as the filter may not know if the objects might be restored shortly.

Because the filter monitors I/O to the file system, the filter can determine when an object that is marked as dead has been restored. The filter may determine this by monitoring for an open request that requests that the object be opened for writing. When this happens, the filter may mark the object in its data structure as alive.

While an object is marked as dead, the filter may not perform any policy enforcement actions related to the object. For example, the filter may not enforce a quota with respect to the object or screen data related to the object. When the object is marked as alive, however, the filter may perform any relevant actions with respect to the object.

The filter may determine whether objects that are marked as dead have actually been deleted upon dismount or remount of the volume upon which the objects reside. If an object no longer exists at either of these times, the metadata 515 may be updated to delete the record that includes a reference to the object.

In addition to validating the records included in the metadata 515, the filter may perform other actions after the metadata 515 has been restored. The metadata 515 may include other data related to a filter that may not be accurate or up-to-date when the metadata 515 is restored. For example, the metadata 515 may include policy information that has changed. To obtain up-to-date information, the filter may query other components (e.g., such as a resource management service that maintains additional policy information) to request the most recent information related to the filter.

As an example of information that may not be accurate, a quota filter may maintain disk usage of objects and their descendants. When the metadata 515 is restored, this information may no longer be accurate. Thus, the filter may initiate a rescan of the objects and their descendants to determine the disk usage of various objects associated with the metadata 515.

It will be recognized that data associated with the metadata 515 other than that described above may also change. The filter may request this other data from other components, recalculate the data, or otherwise obtain the data upon restore without departing from the spirit or scope of the present invention.

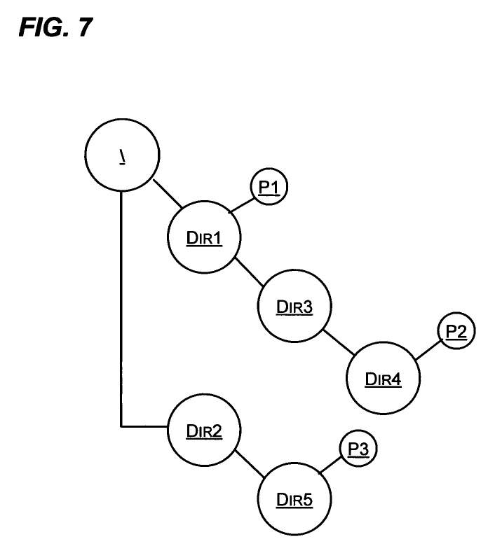

FIG. 7 is a block diagram generally representing a portion of a data structure created by a filter in main memory in accordance with various aspects of the invention. The directory structure includes a root node which has descendants Dir1 and Dir2. The descendant Dir1 has a descendant Dir3 which has a descendant Dir4. The descendant Dir2 has a descendant Dir5.

Policies P1, P2, and P3 are associated with nodes Dir1, Dir4, and Dir5, respectively. Each node may be associated with an object of a file system. As mentioned previously, some of the objects of the file system may not currently exist, even though they are referenced in the metadata used to construct the data structure. Such nodes may be marked as dead. When an object that corresponds to a dead node is created, the node may then be marked as alive.

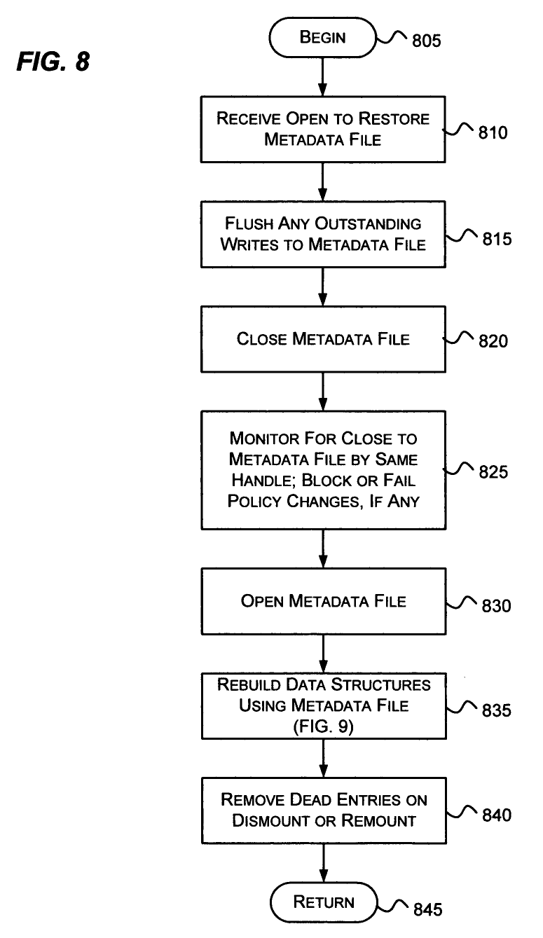

FIG. 8 is a flow diagram that generally represents actions that may occur with restoring a metadata file in accordance with various aspects of the invention. At block 805, the process begins. At this point the filter has an open handle to its metadata file.

At block 810, an open to restore the metadata file is received by the filter. As mentioned previously, this may be indicated by an I/O operation that requests to open the metadata file in write mode with a flag that indicates backup intent.

At block 815, any outstanding writes to the metadata file are flushed. In one embodiment of the invention, outstanding writes are not flushed as the metadata file is expected to be overwritten shortly. In this embodiment, the actions associated with block 815 may not be performed. At block 820, the filter closes the metadata file using the filter's handle.

Between blocks 820 and 825, the application requesting to restore the metadata file is allowed to restore the metadata file. During this time, at block 825, the filter monitors for a close operation to the metadata file that uses the same handle that was used to restore the metadata file. At the same time, the filter blocks or fails any policy changes that are received by the filter. Such changes might be made by a system administrator or the like who is unaware that the metadata file is being restored. Also, during block 825, the filter may continue to perform other actions associated with the filter such as enforcing policies.

At block 830, as the metadata file has been closed by the restore application, the filter opens the metadata file. At block 835, the data structures used to enforce policies are rebuilt as described in more detail in conjunction with FIG. 9. At block 840, dead entries are removed on dismount or remount of the file system. At block 845, the process returns.

FIG. 9 is a flow diagram that generally represents actions which correspond to block 835 of FIG. 8 that may occur in rebuilding data structures in accordance with various aspects of the invention. At block 905, the process begins.

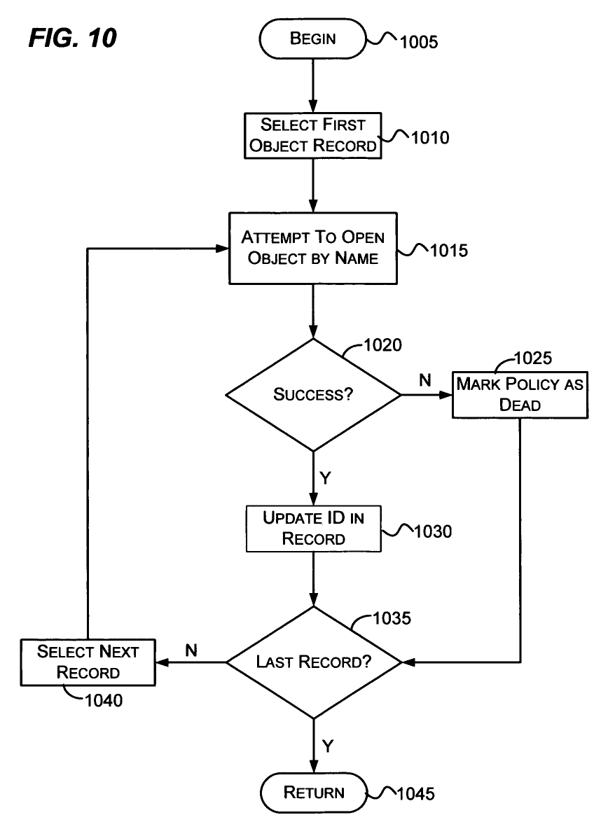

At block 905, the currently existing data structures are deleted from memory. This may involve returning the memory occupied by these data structures to the free pool of memory without actually deleting the contents of the data structures. At block 915, the metadata is re-evaluated to create new data structures in memory corresponding to the new metadata as described in more detail in conjunction with FIG. 10.

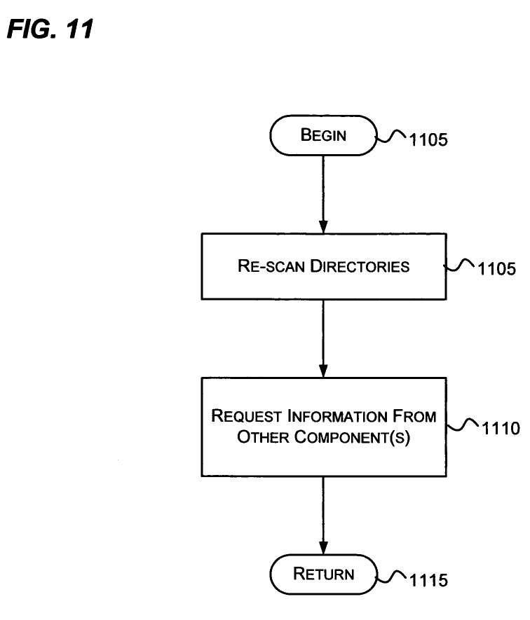

At block 920, events are triggered to update the metadata and data structures in accordance with changes that may have occurred for data associated with other components. Furthermore, such events may also update the metadata with respect to other data (e.g., disk usage) as described previously. Exemplary actions associated with block 920 are described in more detail in conjunction with FIG. 11.

At block 925, the process returns.

FIG. 10 is a flow diagram that generally represents actions which correspond to block 915 of FIG. 9 that may occur in rebuilding data structures in accordance with various aspects of the invention. At block 1005, the process begins.

At block 1010, the first object record of the metadata is selected. At block 1015, an attempt is made to open the object by name. At block 1020, a determination is made as to whether the attempt to open the object by name was successful. If so, processing branches to block 1030; otherwise, processing branches to block 1025.

At block 1025, the policy associated with the object is marked as dead. As described earlier, the object may later be restored, in which case, the policy may then be marked as alive.

At block 1030, the file ID is updated in the record and stored. At block 1035, a determination is made as to whether the currently-selected record is the last record. If so, processing branches to block 1045; otherwise, processing branches to block 1040. At block 1040, the next record is selected. The actions associated with blocks 1015-1040 may be repeated until all records in the metadata have been selected and a data structure such as the one shown in FIG. 7 has been constructed for use by the filter.

At block 1045, the process returns.

FIG. 11 is a flow diagram that generally represents actions which correspond to block 920 of FIG. 9 that may occur in rebuilding data structures in accordance with various aspects of the invention. At block 1105, the process begins.

At block 1105, a re-scan of directories may be commenced. If the metadata includes information that is dependent on data included in directories, the directories may need to be re-scanned. One example of such data is disk space consumed by a directory and its descendants. Another example may be types of objects that are allowed or not allowed to reside in certain directories. If the metadata does not include information that is dependent on data included in directories, the actions associated with block 1105 may be skipped.

At block 1110, information from other component(s) related to the filter is requested. As one example, policy configuration data may be stored by another component and sent to the filter when reconfiguration occurs. To obtain this information immediately after a restore of its metadata, the filter may request it soon after the restore of the metadata.

At block 1115, the process returns.

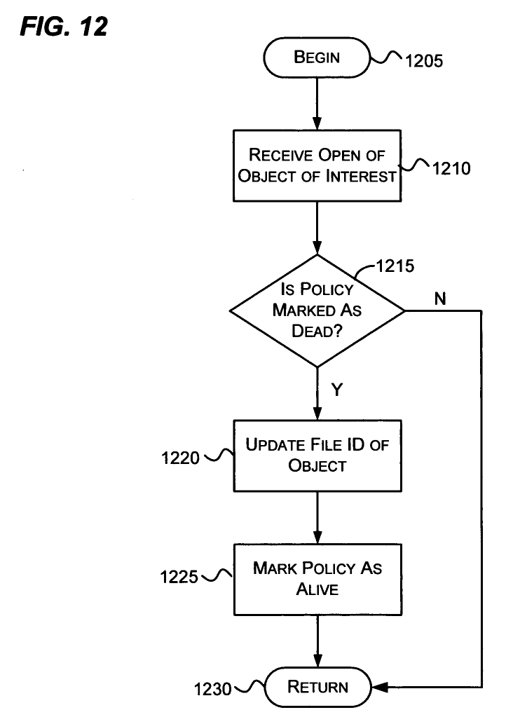

FIG. 12 is a flow diagram that generally represents actions that may occur when an object of interest is restored in accordance with various aspects of the invention. The actions described in conjunction with FIG. 12 take place after a metadata file has been restored and before the volume is dismounted or remounted. At block 1205, the process begins.

At block 1210, an open request is received that requests that an object of interest be created. An object is of interest if it is included in the namespace of the metadata of a filter.

At block 1215, a determination is made as to whether the policy associated with the object is marked as dead. If so, processing branches to block 1220; otherwise, processing branches to block 1230. At block 1220, the file ID of the object is obtained and updated in the metadata.

At block 1225, the policy is marked as alive. Thereafter, any policies associated with the object may be enforced.

At block 1230, the process returns. The process described above may be repeated each time an open for an object of interest is received.

As can be seen from the foregoing detailed description, there is provided a method and system for updating filter data after the filter's metadata file is restored. While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-readable medium having computer-executable instructions, comprising:
receiving a request to restore a metadata file associated with a filter;
in response to the request, closing the metadata file;
determining when the metadata file has been restored; and
from the metadata file, rebuilding data structures maintained by the filter.

2. The computer-readable medium of claim 1, wherein the request is associated with a handle that is used to restore the metadata file.

3. The computer-readable medium of claim 2, wherein determining when the metadata file has been restored comprises monitoring for a close of the handle.

4. The computer-readable medium of claim 1, wherein the filter maintains an open connection to the metadata file until the filter receives the request.

5. The computer-readable medium of claim 1, wherein the metadata file comprises records that identify objects upon which policies are applied.

6. The computer-readable medium of claim 5, wherein the filter enforces the policies.

7. The computer-readable medium of claim 1, wherein the filter monitors inputs and outputs to a file system.

8. The computer-readable medium of claim 7, wherein rebuilding data structures maintained by the filter comprises marking objects that are referenced in the metadata file but that are not included on the file system as dead.

9. The computer-readable medium of claim 8, further comprising marking objects that are marked as dead and then restored as alive.

10. The computer-readable medium of claim 8, further comprising deleting records in the metadata file that correspond to objects that are marked as dead upon remounting the file system.

11. The computer-readable medium of claim 8, further comprising deleting records in the metadata file that correspond to objects that are marked as dead upon dismounting the file system.

12. The computer-readable medium of claim 1, wherein rebuilding data structures maintained by the filter comprises deleting data structures maintained by the filter that existed before the metadata file was restored.

13. The computer-readable medium of claim 1, wherein rebuilding data structures maintained by the filter comprises attempting to open each object referenced in the metadata file.

14. The computer-readable medium of claim 13, further comprising updating the metadata file with a file ID for each object that is successfully opened, wherein the file ID identifies the object to a file system monitored by the filter.

15. The computer-readable medium of claim 1, wherein rebuilding data structures maintained by the filter comprises requesting information from another component associated with the filter.

16. The computer-readable medium of claim 15, wherein the other component comprises a resource management service that maintains additional policy information for policies enforced by the filter.

17. The computer-readable medium of claim 15, wherein rebuilding data structures maintained by the filter comprises rescanning disk usage for objects referenced by the metadata file.

18. The computer-readable medium of claim 1, wherein the metadata file is persisted in non-volatile storage.

19. The computer-readable medium of claim 18, wherein the non-volatile storage comprises a file system for which inputs and outputs are monitored by the filter.

20. The computer-readable medium of claim 1, wherein the data structures are maintained in volatile storage.

21. The computer-readable medium of claim 20, wherein the volatile storage comprises random access memory.

22. The computer-readable medium of claim 1, further comprising blocking or failing policy changes that affect the metadata file.

23. The computer-readable medium of claim 1, further comprising enforcing policies indicated by the data structures after closing the metadata file and before the metadata file is restored.

24. In a computing environment, a method, comprising:
maintaining an open handle to metadata, wherein the metadata is maintained by a filter that has an opportunity to monitor input to and output from storage;
receiving a request to restore the metadata;
closing the open handle to the metadata;
after the metadata is restored, rebuilding data associated with the filter.

25. The method of claim 24, wherein the metadata comprises a file stored on the storage.

26. The method of claim 24, wherein the metadata comprises a database.

27. The method of claim 24, wherein the metadata comprises records that identify objects and policies associated therewith.

28. The method of claim 27, wherein the filter enforces the policies.

29. The method of claim 24, wherein rebuilding data associated with the filter comprises:
deleting data structures associated with the metadata from memory;
re-evaluating the metadata to rebuild new data structures; and
triggering events to obtain additional information from other components associated with the filter.

30. The method of claim 29, wherein re-evaluating the metadata to rebuild new data structures, comprises attempting to open each object referenced by the metadata by name.

31. The method of claim 30, further comprising if an attempt to open an object is successful, updating a file ID in the metadata that identifies the object to the storage.

32. The method of claim 30, further comprising if an attempt to open an object is not successful, marking a policy associated with the object as dead.

33. The method of claim 32, wherein the filter does not enforce policies for objects that are marked as dead.

34. The method of claim 31, further comprising triggering events to obtain updated information regarding objects referenced by the metadata.

35. The method of claim 34, wherein the updated information regarding objects referenced by the metadata comprises an amount of space consumed by the objects and their descendants.

36. An apparatus for updating data in response to file system changes, comprising:
a metadata file arranged to store metadata; and
a filter arranged to monitor input to and output from a volume and to perform actions, comprising:
receiving an input operation that indicates that the metadata file is to be restored;
in response to the input operation, closing the metadata file;
determining when the metadata file has been restored;
from the metadata file, rebuilding data structures maintained by the filter, wherein the data structures are employed by the filter in enforcing policies on the volume.

37. The apparatus of claim 36, wherein the filter comprises a quota filter that enforces disk space usage of each object referenced by the metadata.

38. The apparatus of claim 36, wherein the filter comprises a data filter that restricts what types of objects are stored on the volume.

39. The apparatus of claim 36, wherein the data structures comprise nodes that identify objects and policies associated therewith.
